(19) United States
(12) Patent Application Publication
(10) Pub. No.: US 2023/0077173 A1
(43) Pub. Date: Mar. 9, 2023

(54) INFORMATION MANAGEMENT SYSTEM AND METHOD

(71) Applicant: Mathew Rotenberg, New York, NY (US)

(72) Inventor: Mathew Rotenberg, New York, NY (US)

(21) Appl. No.: 17/468,006

(22) Filed: Sep. 7, 2021

(51) Int. Cl. G06Q 10/10; G06F 3/0482; G06F 3/0481; G06F 16/93

(52) U.S. Cl. CPC G06Q 10/101; G06F 3/0482; G06F 3/04817; G06F 16/94

(57) ABSTRACT

An information management system is disclosed, including at least one user computing device in operable connection with a user network. An application server is in operable communication with the user network to host an application system for providing a platform managing information related to a project. The application system having a user interface module for providing access to the application system through the user computing device. A document module receives the document from a document management API to permit the creation, editing, and transmittal of a document associated with a project. A project management module an and email integration module are each operable to associate information contained in emails, documents, etc. to associate the information with a project. A communication module permits collaborative engagement with the document.

### CROSS-REFERENCE TO RELATED APPLICATIONS

The present application claims priority to U.S. Provisional Patent Application No. 63/049,045 filed Jul. 7, 2020, entitled “INFORMATION MANAGEMENT SYSTEM,” which is hereby incorporated by reference in its entirety.

### TECHNICAL FIELD

The embodiments generally relate to computer implemented systems for workstream management.

### BACKGROUND

Each time an employee is requested to produce documents or information, they are tasked with searching through their entire email inbox in order to retrieve the most up to date information, analyze the information, and perform a response action. This can be difficult in instances where there are multiple email streams for a single matter. This requires the employee to constantly re-orient themselves to contextualize a workstream. As a result, this process is fragmented, inefficient, and outdated.

In one example, transactional attorneys often manage a large number of individual clients who may each have multiple matters. When a client requests information from the attorney, it can be difficult for the attorney to associate themselves with the matter using traditional email systems.

While client management tools exist in the current arts, many of these tools are lacking in various aspects which may add convenience and efficiency. For example, many current systems do not allow for collaborative and communal access to documents. Further, many of these systems lack a tool for accessing and editing working documents.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to an information management system is disclosed, including at least one user computing device in operable connection with a user network. An application server is in operable communication with the user network to host an application system for providing a platform managing information related to a project. The application system having a user interface module for providing access to the application system through the user computing device. A document module receives the document from a document management API to permit the creation, editing, and transmittal of a document associated with a project management module to receive a plurality of information and to correlate the information to at least one project. An email integration module is in operable communication with the project management module, the email integration module to display an email API onto a user dashboard, the email integration module to aggregate emails onto the user dashboard displays a plurality of projects each associated with at least one client. A communication module permits collaborative engagement with the document.

The embodiments provided herein provide an advantageous platform to integrate email and project management API's such that the user may access project information, collaborate on matters associated with a project, edit documents, and communicate with clients in a single web-based application. This removes the need to interact with various API's to communicate with clients and interact with various tasks associate with a project.

The embodiments provided herein provide an efficient and effective means of managing various aspects of a workstream without the need to navigate between various APIs. The embodiments provide a single platform which users can intake clients and communicate with clients and other users in their network. Further, the platform allows the user to interact with documents, autofill forms, edit documents, define terms, and otherwise complete a workstream.

In some aspects, the information management system includes at least one database configured to store a plurality of information, comprising client information, matter information, and workstream information, each presented on a user interface provided on a computing device. A processor to receive the plurality of user information, the client information, the matter information, and the workstream information and associate each to a client and a matter via a plurality of dashboard icons.

The system may be utilized to contextualize workstreams to provide an efficient system for aggregating and organizing information related to a plurality of matters. The system provides an organized user interface which presents information based on user preferences and by aggregating information into client, matter, and workstream subcategories. The user interface provides sorted emails, documents, a chat feature, and a deadline lists (such as a checklist, action board, or the like).

The system allows for the collaborative sharing and editing of documents via a redline module, such that users can view edits while accepting or denying changes to the edits within a working document.

In one aspect, a machine learning engine is configured to analyze the plurality of information and automatically associate the client information with the client and the matter. The machine learning engine may provide recommendations from information stored in the client database, project database, communications transmitted and received via the network, or from information input in the user dashboard.

In one aspect, the client and matter are associated to at least one dashboard icon provided on the user interface.

In one aspect, the dashboard icon is selectable to present the plurality of information associated with the client and the matter.

In one aspect, the embodiments provide a computer program product comprising a non-transitory computer-usable medium having computer-readable project code embodied therein. The computer readable program code, when executed by a computing system, causes the computing system to implement a method including receiving, via a user, a plurality of client information associated with a client. The client database stores the plurality of client information, and a user creates at least one project associated with the client. A project database stores a plurality of project information and permitting access to the plurality of project information via a user dashboard. A case management API schedules one or more deadlines associated with the project. A document management API manages at least one document associated with the project.

In one aspect, a redline module allows editing of one or more documents associated with a project which can be transmitted via a communication module to the one or more documents to a third-party computing device.

In one aspect, the communication module is in operable communication with an email server API to integrate one or more emails and display the one or more emails via the user dashboard.

In one aspect, the document management API is in operable communication with the user dashboard to display one or more documents associated with each client.

In one aspect, the embodiments include a term definition module to associate a definition input via the user with one or more terms in the document. A hyperlink is generated which may be selected by the user to display the definition following the selection of the hyperlink.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a block diagram of the application program, according to some embodiments;

FIG. 4 illustrates a screenshot of the client dashboard, according to some embodiments;

FIG. 5 illustrates a screenshot of the communications interface, according to some embodiments;

FIG. 6 illustrates a screenshot of the workstreams interface, according to some embodiments;

FIG. 7 illustrates a block diagram of system to provide an integratable API, according to some embodiments;

FIG. 8 illustrates a flowchart of a process for the collaborative editing of a document using the user dashboard, according to some embodiments;

FIG. 9 illustrates a flowchart of a process for defining a term and associated the definition of the term with a hyperlink provided on the user dashboard, according to some embodiments; and

FIG. 10 illustrates a flowchart of a process for providing an information management system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” may relate to any person interacting with the system and may be most useful for employees who manage a workstream comprising a plurality of clients and matters related thereto. Although the utilization of the system by attorneys is given as an example herein, one skilled in the arts will readily understand that the embodiments may be utilized by other industries and professionals.

In general, the embodiments provided herein relate to a system for managing a workstream (e.g., an attorney's docket) using a computing device. The system may be utilized to contextualize workstreams to provide an efficient system for aggregating and organizing information related to a plurality of matters. The system provides an organized user interface, which presents information based on user preferences. For example, the user may select to organize information by client and, furthermore, by each matter associated with a particular client such that when the user selects a client and/or matter, they are only provided information associated with the client and/or matter.

The system includes various features, including a user interface providing a user dashboard which is downloaded to the desktop application. Once the platform (whether provided on a desktop application, web application, etc.) is opened, the interface is presented, showing emails, messages, and functional features. A plurality of customizable dashboard icons may be presented. In some embodiments, each dashboard icon is associated with a client and/or matter. Selecting the dashboard icon displays all relevant information for the client/matter that the dashboard icon is associated.

In some embodiments, the system provides a chat feature to permit the user to communicate and collaborate with colleagues or other users of the system. The chat features may provide notifications to the user when a chat is received, read, and the like.

In some embodiments, the system provides a checklist of items which may help the user with prioritizing work, tracking deadlines, and/or tracking progress. The checklist may be shared with other users to allow others in the network to view and/or interact with the checklist.

In some embodiments, the system provides email integration, allowing the system to analyze, sort, and aggregate emails into appropriate dashboard icons. For example, all emails received from a client will be automatically transmitted to the dashboard icon associated with the client. The email may also be a duplicate such that the email is visible in the main email interface, as well as in the dashboard icon interface associated with the client.

In some embodiments, the system provides workstream for a particular matter (e.g., a specific agreement, regulatory approval, contract, review, or other unique workstream). The user may then interact with the workstream by viewing, editing, or transmitting the workstream to other users.

In some embodiments, a documents interface allows the user to access, edit, and transmit documents without requiring the user to retrieve the documents from third-party services (e.g., word processing engines, email, and the like). The documents interface may permit users to drag and drop documents from the email system or workstream system to engage with the document therein. Further, the system may allow for redlining documents. The redlining engine may also compare documents and automatically generate redlining notations where changes have been made.

Applications may be integrated into the system via third-party providers. For example, billing systems, forms builders, document review systems, e-signature systems, and the like.

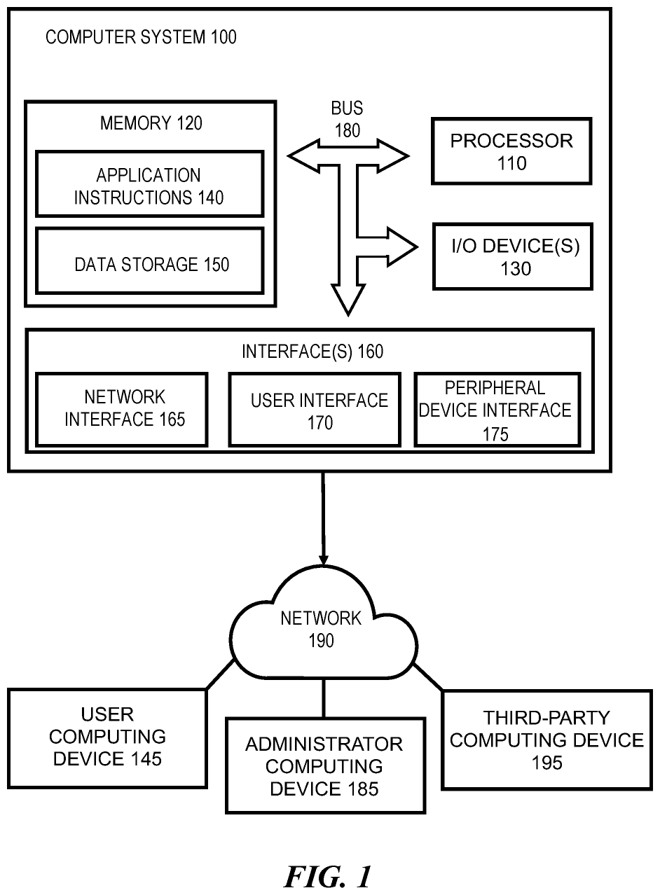

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by the user to interact with the various functionalities of the system. In one example, the user computing device 145 may be utilized to communicate with clients, attorneys or other associated personnel utilizing the system. The user computing device 145 may allow the user to collectively perform tasks such as editing and reviewing documents, sharing project boards, managing dockets, transmit and receive emails, etc. The administrator computing device 185 is utilized by an administrative user to moderate content and to perform other administrative functions. The third-party computing device 195 may be utilized by third parties to receive communications from the user computing device 145, transmit communications to other users, clients, or third parties.

In some embodiments, the third-party computing device 195 may be operated by opposing council, outside counsel, paralegals, clients, or other users who are in communication with the user. This allows the system to be a collaborative platform to complete tasks, communicate regarding each task, track progress, and view dockets in real-time.

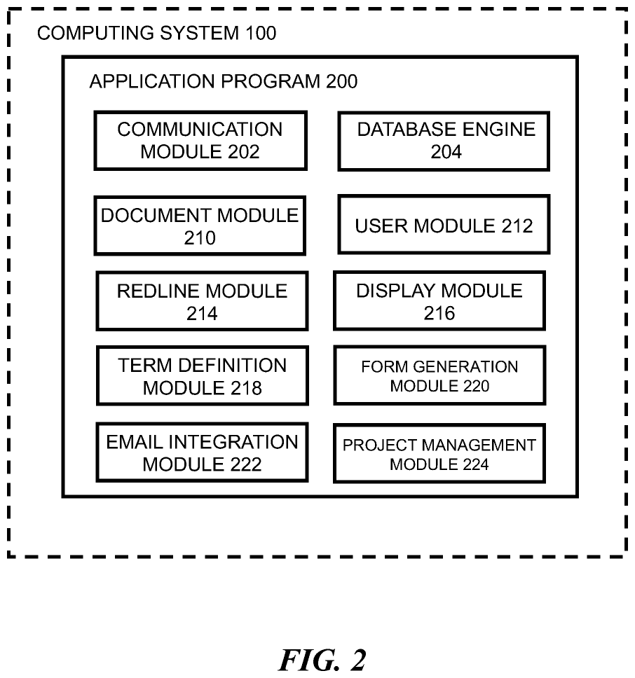

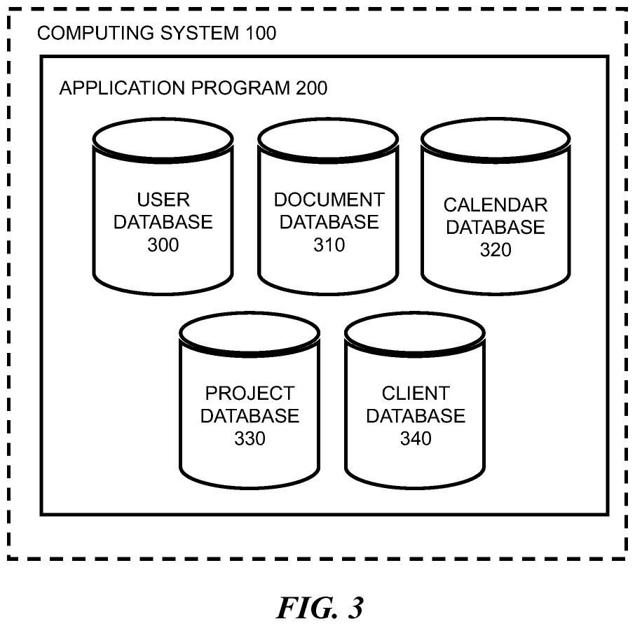

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a document module 210, a user module 212, a redline module 214, a display module 216, a term definition module 218, a form generation module 220, an email integration module 222, and a project management module 224.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 allows the user to communicate with other users, communicate with clients, support staff (e.g., paralegals, other associates, administrators, etc.) and the like. The communication module 202 may facilitate the reception and transmittal of documents, forms, edits/redlining, emails, and other transfer of data and communications associated therewith.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. In some embodiments, the database engine 204 transmits and receives information from a plurality of databases described in FIG. 3 herein.

In some embodiments, the document module 210 is in communication with a word processing system which allows the user to create a document. For example, the document module may receive data from a word processing system and displays the document on the user dashboard to allow each user in communication with the network to access the document, review the document, edit the document, and transmit the document via the communication module 202.

In some embodiments, the user module 212 facilitates the creation of a user account for the application system. The user module 212 may allow the user to create a user profile to engage with the various functionalities of the system. The user module 212 may be associated with user permissions based on the user's credentials and permit access to specific content.

In some embodiments, the redline module 214 is configured to allow one or more users to edit a document and generate redlines (or other form of markup) associated with each edit. The redline module 214 is in operable communication with the document module 210 to access the document and indicate where edits are made by the user(s). The redline module 214 may allow multiple user to collaboratively edit one or more documents. Once edits are made, the communications module may transmit the edits to other users or third parties.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. In some embodiments, the display module 216 may be operable to display the user's docket, communications, calendar, redline edits, terms, forms, and the like.

In some embodiments, the term definition module 218 allows the user to define terms throughout a document and readily view term definitions. For example, the user enters a term and term definition which generates a selectable hyperlink on the term when viewing the document. Once the user selects the term, the display module 216 displays the term definition to allow the user to efficiently define and reference terms throughout a document. In some embodiments, the definition of the term is displayed, via the display module 216, in a pop-up window.

In some embodiments, a form generation module 220 allows the user to generate forms associated with a task. For example, the forms may be legal forms which can be automatically filled using information input by the user (e.g., an attorney, client, etc.).

In some embodiments, the email integration module 222 permits the integration of emails from a group of users to allow emails to be shared and interacted with by the group of users. For example, users may be grouped by a project which they are each working collaboratively on. The email integration module 222 may parse emails to each user associated with a project or subtask of each project. In some embodiments, the email integration module 222 may interpret, via an AI engine, manual parsing, or other implement to transmit relative emails and content to each user to which the email and/or content applies.

In some embodiments, the project management module 224 receives information provided by each user and/or third-party user and associated the information with one or more project with which each user is interacting. The project management module 224 may utilize word recognition engine and comparator to compare key terms in an email, document, notes, or other information to determine which project the information applies. The project management module 224 may be in operable communication with the email integration module 222 to ensure that emails, notes, documents, etc. are categorized into appropriate regions of the user dashboard to automatically provide users with all information pertaining to each project they are engaged with.

FIG. 3 illustrates the computing system 100 in operable communication with the application program 200 having a plurality of databases in communication thereto. A user database 300 is operable to store user information such as user preferences, user profile information, historical usage data, historical content, communications information, user workflows, projects associated with the user, the user's scheduling information, etc. The documents database 310 stores documents generated by a word processing system. Each document may be stored in the document database 310 to allow the user to access the document as needed. The calendar database 320 stores information input into a calendar including project deadlines, regulatory deadlines, meetings, conferences, and the like. The project database 330 stores information associated with a project such as client disclosures, project details, project milestones, etc. The client database 340 stores client information which may be utilized by the user to complete a project.

The application program 200 may in operable communication with the project management module 224 to parse information from each database to an appropriate project. For example, the project management module 224 and email integration module 222 may be operable to sort, transmit, and receive information to and from the project database 330. In such, relevant emails, documents, client information, calendar information etc. is accessible via the user or client dashboards.

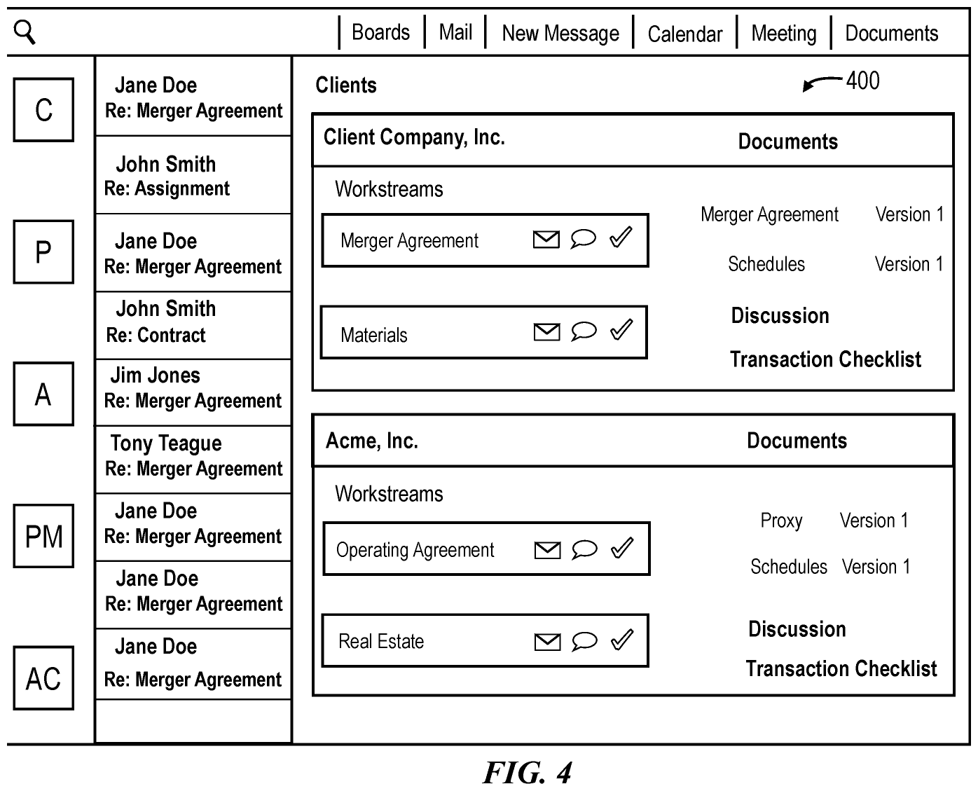

FIG. 4 illustrates a screenshot of the client dashboard 400 comprising a plurality of dashboard icons each corresponding to a client. Selecting a dashboard icon allows for the user to view information corresponding to the client including emails, workstreams, documents, discussions, transactions, and the like. The client dashboard 400 allows the user to view boards, mail, create new messages, view a calendar interface, interact with a meeting interface, and interact with documents via selectable tabs. The client dashboard 400 allows the user to maintain each of the functionalities described herein, while allowing the user to customize and organize their user interface to display information per their unique user preferences. This information is provided by the project management module and provides an organized view of the project status, communications, and documents. The client dashboard 400 is integrated with an email platform, such that all project tasks are organized in the email platform without requiring the user to navigate to third-platforms, utilize browser extensions, etc.

In some embodiments, the client dashboard 400 may allow the user to select a project (e.g., a merger agreement, schedule, etc. and view the document associated therewith. The user may then edit the document, submit redline edits, transmit the document to other users, or otherwise interact with the project and tasks thereof.

In some embodiments, each client includes a workstream comprised of the relevant documents, deadlines, contact information, discussions and other communications, transactions, and other information associated with the workstream.

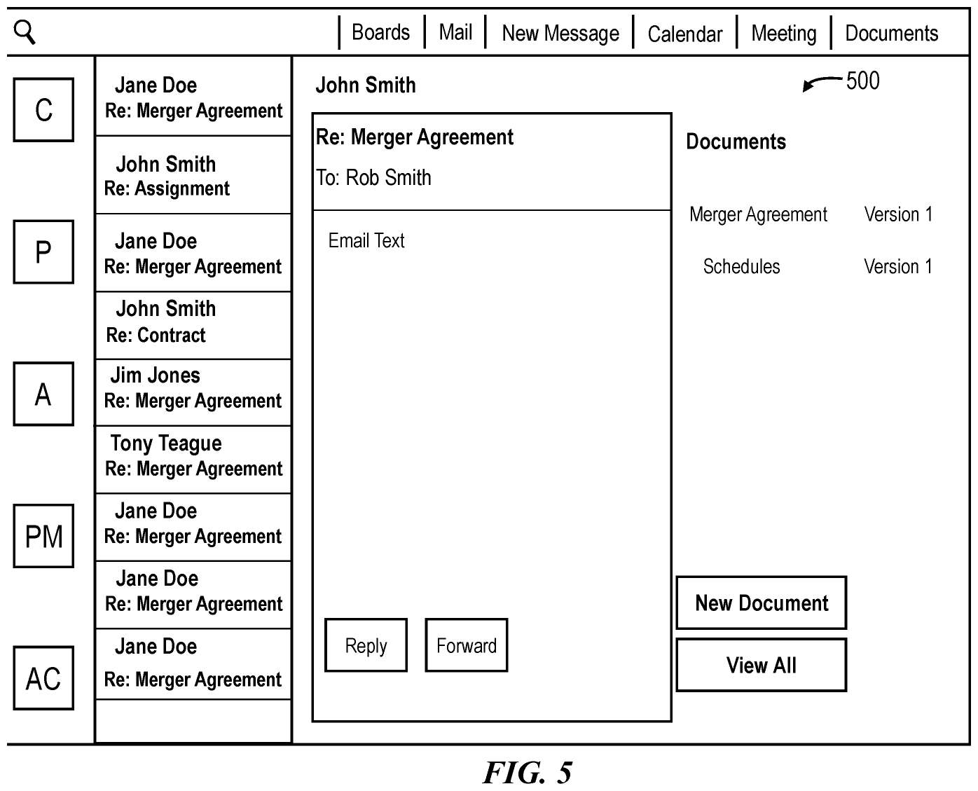

FIG. 5 illustrates a screenshot of the communications interface 500 wherein the user may generate and transmit communications to other users of the system, or to external communications systems including email systems, third-party messaging services, and the like. The communications interface 500 provides the user with an automated system for organizing communications from each client and/or matter to allow the user to easily access information. The user may interact with documents for related to each client as well as create new documents. The documents may be saved into the memory allowing the user to make edits, redline, or otherwise amend the document. New documents are automatically associated with the client/matter with which it relates.

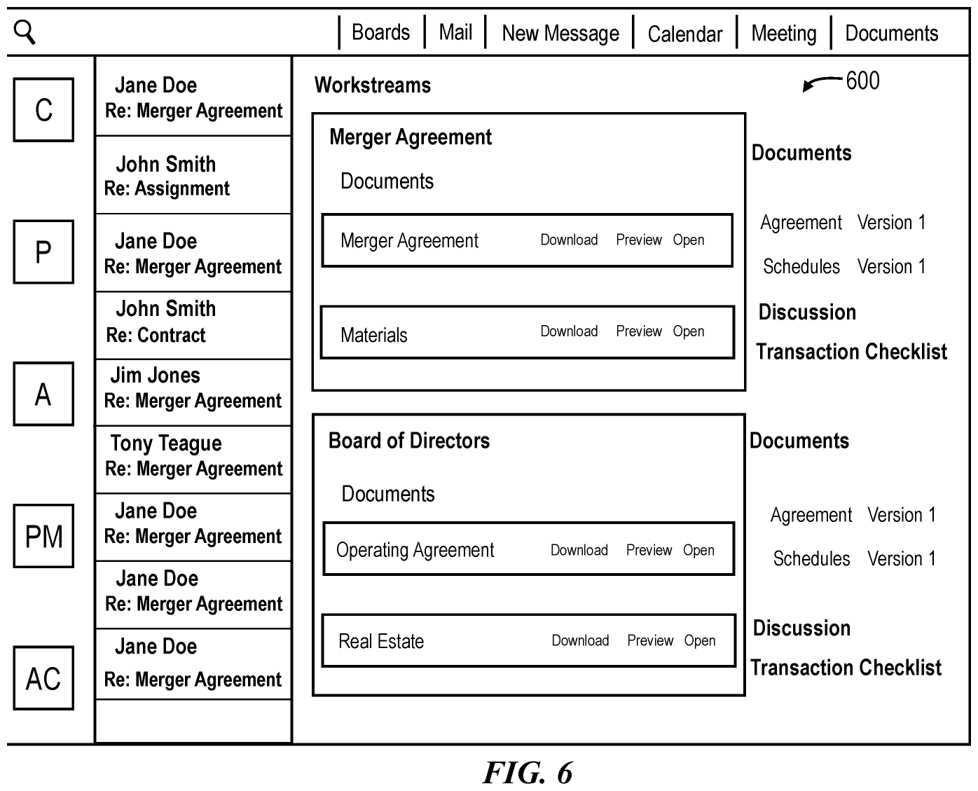

FIG. 6 illustrates a screenshot of the workstreams interface 600 wherein the user can view, and access information related to workstreams for a particular client/matter which may include various documents, statuses, transactions, and discussions. The user may download documents, preview documents, and open documents on the interface without using a third-party system. The system may automatically transmit workstreams between clients/matters.

In some embodiments,

In some embodiments, the communications interface 500 and/or the workstreams interface 600 may include a chat interface to allow the user to input communications which are transmitted to other users of the system. The communications interface may permit users to collaborate with others regarding a project, action item, and the like. Communications in the chat feature may be selectively kept private based on user input, or only transmitted to user-determined devices within the network. Further, the communications interface 500 and/or the workstreams interface 600 may include a checklist feature which allows the user to input a plurality of action items, projects, or tasks and check a selectable tab once the action items, projects, or task has been completed. The checklist may be specific to a user or group thereof as a means of tracking productivity, tracking progress, or for organization.

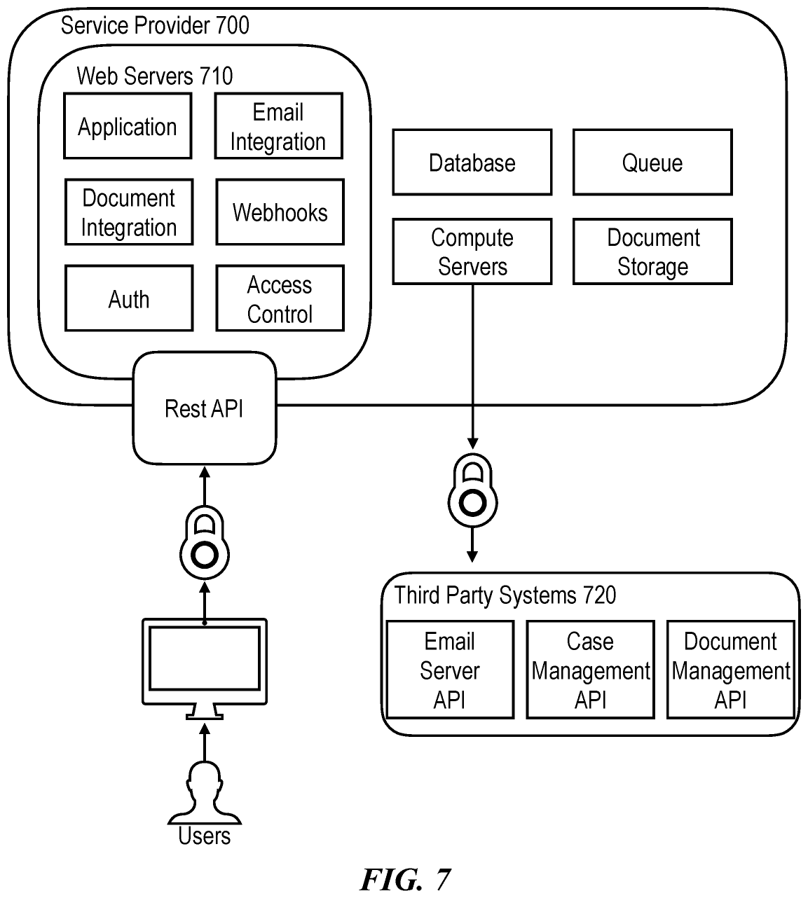

FIG. 7 illustrates a block diagram of the system which comprises a service provider 700 (e.g., a cloud service provider) in operable communication with web servers 710. The web servers 710 comprise a plurality of systems including the application, email integration, document integration, Webhooks, authorizations, and access control. The cloud service provider 700 may also comprise one or more databases, compute servers, queues, and document storage systems. Third party systems 720 (e.g., email server API's, case management APIs, and document management API's may be in operable communication via computer servers.

In some embodiments, the case management API permits the integration of case management information including deadlines, regulatory materials associated with the project.

In some embodiments, the system is in operable communication with a machine learning engine to analyze user organization preferences to aggregate information into appropriate client/matter folders. The machine learning engine may determine an appropriate client/matter, document type, redline edits, recipient of communications, and the like. The machine learning engine may be in operable communication with the calendar module to suggest meeting times, suggest actions associated with a project, or otherwise recommend tasks to be accepted or denied by the user.

In some embodiments, the system permits access to third-party systems 520 which are integrated with the system described by the embodiments described herein. For example, case management API may be in communication with the document module to permit case documents to be viewed, edited, and otherwise interacted with. In another example, a document management API is in communication with the redline module to allow the user to generate redline edits on a documents and share the redline edits with other users of the system.

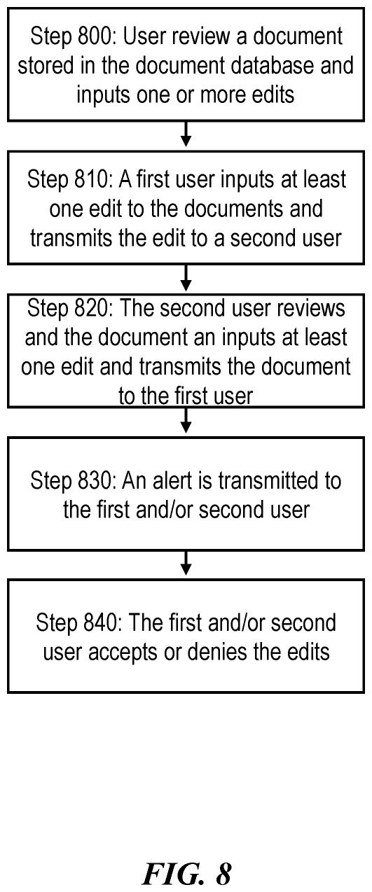

FIG. 8 illustrates a flowchart of a process for the collaborative editing of a document using the user dashboard. In step 800, the user reviews a document stored in the document database and inputs one or more edits. In step 810, a first user inputs at least one edit to the document and transmits the edit to a second user. In step 820, the second user reviews the document and inputs at least one edit and transmits the document to the first user. In step 830, an alert is transmitted to alert the first user or the second user of the edits. The alert may be displayed on the user dashboard. In step 840, the first user or the second user accepts or denies each edit input in the document. One skilled in the arts will readily understand that the process may continue in perpetuity until a user accepts the changes and no additional changes are needed for the document.

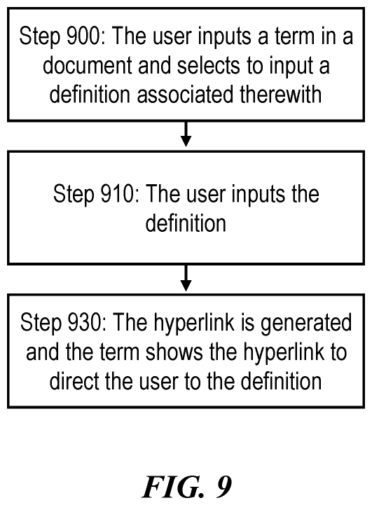

FIG. 9 illustrates a flowchart of a process for defining a term and associated the definition of the term with a hyperlink provided on the user dashboard. In step 900, the user inputs a term in a document and selects to input a definition associated with the term. In step 910, the user input the definition associated with the term. In step 920, the term definition module generates a hyperlink such that if selected, the definition of the term is displayed.

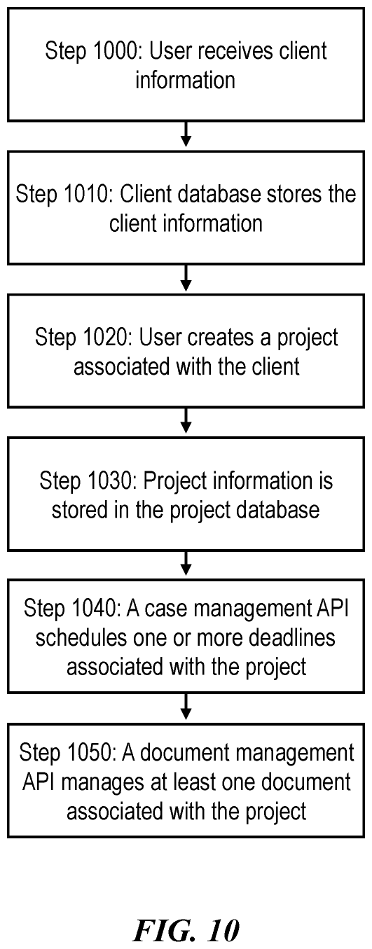

FIG. 10 illustrates a flowchart of a process for providing an information management system. In step 1000, a user receives a plurality of client information associated with a client. In step 1010, the client database stores the plurality of client information and in step 1020, the user creates at least one project associated with the client. In step 1030, project information is stored in the project database and access is permitted to the project information. The user may view the client information, project information, and other associated information on their user dashboard. In step 1040, a case management API schedules one or more deadlines associated with the project. In step 1050, a document management API manages at least one document associated with the project.

In some embodiments, the case management API, document management API, and email server API are displayed as overlays on the user dashboard. This allows the user to view each API on the user dashboard without navigating back and forth between each API and the user dashboard. In such, the user may access, create, and edit documents via the document management API without navigating away from their user dashboard.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1-19. (canceled)

20. A system comprising:
at least one processor;
at least one display device; and
memory storing instructions that, when executed by the at least one processor, cause the system to perform operations comprising:
allowing a first computing device of a first user to access an application system;
displaying, simultaneously, a plurality of dashboard components comprising, at least:
a first dashboard icon corresponding to a first client of the first user;
a second dashboard icon corresponding to a second client of the first user;
a workstream section;
an email section;
contextualizing a plurality of workstreams.

21. The system of claim 20,
wherein the contextualizing the plurality of workstreams comprises:
aggregating information into subcategories comprising:
a client subcategory;
a matter subcategory; and
a workstream subcategory.

22. The system of claim 20,
wherein the contextualizing the plurality of workstreams comprises:
automatically integrating a plurality of emails.

23. The system of claim 22,
wherein the automatically integrating the plurality of emails comprises:
aggregating from the plurality of emails, into a first email subset, all emails received from the first client of the first user.

24. The system of claim 23,
wherein the automatically integrating the plurality of emails comprises:
associating the first email subset with the first dashboard icon;
aggregating from the plurality of emails, into a second email subset, all emails received from the second client of the first user;
associating the second email subset with the second dashboard icon.

25. The system of claim 24, the operations further comprising:
receiving a first selection of the first dashboard icon corresponding to the first client of the first user;
in response to receiving the first selection of the first dashboard icon associated with the first client of the first user, only providing first information associated with the first client of the first user.

26. The system of claim 25, the operations further comprising:
receiving a second selection of the second dashboard icon corresponding to the second client of the first user;
in response to receiving the second selection of the second dashboard icon associated with the second client of the first user, only providing second information associated with the second client of the first user.

27. The system of claim 26, the operations further comprising:
receiving a third selection of a first matter associated with the second client of the first user;
in response to receiving the third selection of the first matter associated with the second client of the first user, only providing third information associated with the first matter associated with the second client of the first user.

28. The system of claim 21, the operations further comprising:
receiving a first selection of the first dashboard icon corresponding to the first client of the first user;
in response to receiving the first selection of the first dashboard icon associated with the first client of the first user, only providing first information associated with the first client of the first user.

29. The system of claim 28, the operations further comprising:
receiving a second selection of the second dashboard icon corresponding to the second client of the first user;
in response to receiving the second selection of the second dashboard icon associated with the second client of the first user, only providing second information associated with the second client of the first user.

30. The system of claim 29, the operations further comprising:
receiving a third selection of a first matter associated with the second client of the first user;
in response to receiving the third selection of the first matter associated with the second client of the first user, only providing third information associated with the first matter associated with the second client of the first user.

30. The system of claim 20,
wherein the first user is a first attorney.

31. The system of claim 30,
wherein the plurality of workstreams comprises a first docket.

32. The system of claim 29,
wherein the first user is a first attorney.

33. The system of claim 32,
wherein the plurality of workstreams comprises a first docket.

34. The system of claim 27,
wherein the first user is a first attorney.

35. The system of claim 34,
wherein the plurality of workstreams comprises a first docket.

36. The system of claim 24,
wherein the first user is a first attorney.

37. The system of claim 36,
wherein the plurality of workstreams comprises a first docket.

38. The system of claim 37,
wherein each workstream of the plurality of workstreams comprises, at least:
one or more documents;
one or more deadlines;
contact information; and
one or more discussions.

39. A computer-implemented method, comprising:
allowing a first computing device of a first user to access an application system, wherein the application system comprises:
one or more databases comprising a user database, a document database, a project database, and a client database;
displaying, simultaneously, a plurality of dashboard components comprising, at least:
a first dashboard icon corresponding to a first client of the first user;
a second dashboard icon corresponding to a second client of the first user;
a workstream section;
an email section;
contextualizing a plurality of workstreams, wherein the contextualizing the plurality of workstreams comprises:
aggregating information into subcategories comprising:
a client subcategory;
a matter subcategory; or
a workstream subcategory;
automatically integrating a plurality of emails, wherein the automatically integrating the plurality of emails comprises:
aggregating from the plurality of emails, into a first email subset, all emails received from the first client of the first user;
associating the first email subset with the first dashboard icon;
aggregating from the plurality of emails, into a second email subset, all emails received from the second client of the first user;
associating the second email subset with the second dashboard icon;
receiving a first selection of the first dashboard icon corresponding to the first client of the first user;
in response to receiving the first selection of the first dashboard icon associated with the first client of the first user, only providing information associated with the first client of the first user
receiving a second selection of the second dashboard icon corresponding to the second client of the first user; and
in response to receiving the second selection of the second dashboard icon associated with the second client of the first user, only providing information associated with the second client of the first user.

40. A non-transitory computer-readable storage medium having stored thereon executable instructions that, when executed by one or more processors of a computer system, cause the computer system to perform operations comprising:
allowing a first computing device of a first user to access an application system;
displaying, simultaneously, a plurality of dashboard components comprising, at least:
a first dashboard icon corresponding to a first client of the first user;
a second dashboard icon corresponding to a second client of the first user;
contextualizing a plurality of workstreams, wherein the contextualizing the plurality of workstreams comprises:
automatically integrating a plurality of emails, wherein the automatically integrating the plurality of emails comprises:
aggregating from the plurality of emails, into a first email subset, all emails received from the first client of the first user;
associating the first email subset with the first dashboard icon;
aggregating from the plurality of emails, into a second email subset, all emails received from the second client of the first user;
associating the second email subset with the second dashboard icon;
receiving a first selection of the first dashboard icon corresponding to the first client of the first user; and
in response to receiving the first selection of the first dashboard icon associated with the first client of the first user, only providing information associated with the first client of the first user;
permitting the first user to communicate and collaborate with other users;
providing notifications to the first user when a chat is received or read;
providing a checklist of items to assist the first user with prioritizing work, tracking deadlines, and tracking progress;
sharing the checklist with the other users;
allowing the first user to access, edit, and transmit documents without requiring the first user to retrieve the documents from third-party services;
permitting the first user to drag and drop the documents;
allowing redlining the documents, wherein the redlining comprises comparing the documents and automatically generating redlining notations;
allowing the first user to collectively perform tasks comprising sharing project boards and managing dockets;
allowing the first user to define terms throughout the documents and view term definitions.
